(19) United States
(12) Patent Application Publication
(10) Pub. No.: US 2005/0098563 A1
(43) Pub. Date: May 12, 2005

(54) Cryostat with an inner container for receiving a microtome

(75) Inventor: Stefan Kunkel, Karlsruhe (DE)

Correspondence Address: FOLEY AND LARDNER;SUITE 500, 3000 K STREET NW, WASHINGTON, DC, 20007, US

(73) Assignee: LEICA MICROSYSTEMS NUSSLOCH GmbH

(21) Appl. No.: 10/983,640

(22) Filed: Nov. 9, 2004

(30) Foreign Application Priority Data
Nov. 11, 2003 (DE) 103 52 575.0

(51) Int. Cl. F25D 3/12; F17C 1/00; F17C 3/00; F17C 13/00

(52) U.S. Cl. 220/560.04; 220/560.12

(57) ABSTRACT

A description is given of a cryostat (1) with an inner container (2). For improved cleaning and disinfection, the wall (4) of the inner container (2) has a doping (5) or coating (9) for the release of silver ions (8).

The invention relates to a cryostat for cutting frozen specimens and preparations with an inner container for receiving a microtome.

Cryostats of this type are known and are used everywhere where specimens and preparations that are to be investigated, for example soft biological material, first have to be cooled to a very low temperature in order that they can subsequently be cut to the desired thickness without any problem by the microtome. The inner container of a cryostat in this case generally forms a cooled chamber in which a microtome for cutting frozen specimens for subsequent microscopic investigation is arranged. The low temperature produced in the inside container by means of the coolant referred to as cryogen causes the specimen that is to be investigated to be cooled rapidly to what is known as the cutting temperature of typically −10 to −50 degrees Celsius.

To ensure unproblematical cutting of the preparations, elaborate temperature control is necessary, for example setting a specific temperature difference between the microtome cutter and the frozen specimen.

The specimens to be investigated are often contaminated or bacterially charged biological material. Cutting of the specimens with the microtome unavoidably produces fine cutting waste, which falls from the microtome cutter and distributes itself inside the container.

To avoid infections from the contaminated cutting waste, the operating personnel are obliged to intensively clean and disinfect the interior space at relatively frequent time intervals. For this purpose, the container is opened and a liquid disinfectant, for example an agent with the designation “Cryofect”, is sprayed onto the walls of the inner container and rubbed off with a cloth.

Solvent-containing disinfectants adversely affect the skin and organism of the operating person.

With this procedure, there is of course the difficulty that the corners and inner edges of the container can only be reached with difficulty, and consequently reliable disinfection of the inner container is problematical to perform and takes a correspondingly long time.

Added to this is the fact that opening the container causes the temperature in the interior of the cryostat to change abruptly, so that cleaning is additionally made more difficult by the effects of ice and moisture formation. The manual cleaning operation with the device open requires a certain amount of time, in which the temperature of the cryostat moves away considerably from its working temperature.

The circumstances described have the result that rapid, troublefree reoperation of the cryostat after it has been used for example with bacterially charged material is not ensured. More rapid cooling to the working temperature, and consequently more rapid establishment of operational readiness, may at best be at the expense of increased energy consumption of the cooling device.

The object of the present invention is therefore to provide a cryostat with simplified disinfection of its inner container.

This object is achieved according to the invention by the inner container having a coating with soluble silver ions or being made of a material which is doped with soluble silver ions. Advantageous refinements and developments of the invention are provided by the features of the subclaims.

The invention is distinguished by the fact that the surface of the inner container for receiving the microtome has a direct antibacterial and disinfectant effect on adhering and falling-off contaminated cuttings.

Many antimicrobial materials are degraded over time or not suitable for use on metal. Furthermore, the antimicrobial or antiseptic effect changes with temperature. However, outstanding results, without the aforementioned disadvantages, have been obtained even at low temperatures on metal surfaces doped or coated with free silver ions.

In a refinement of the invention, the coating comprises a release system with constant and controlled liberation of silver ions, in order to provide a reliable antibacterial effect of the silver ions over a long period of time. The coating may in this case consist of a ceramic material as a carrier for storing the silver ions, which allows varied coating technology for application to metal surfaces and at the same time ensures a maximum antimicrobial effect.

In a further refinement of the invention, the release system can be activated by the moisture of the air in the interior space of the cryostat and in this way ensures effective and long-lasting protection from bacteria, mildew and fungal attack.

The inner container is advantageously formed in one piece, so that difficult-to-clean joins, corners and edges are avoided.

For this purpose, it is particularly advantageous if the inner container of the cryostat is produced by the deep-drawing process. The application of the doping or coating can then be carried out in a particularly simple way.

Making the inner container from high-grade steel ensures not only good thermal conductivity but also outstanding durability.

The use of an inner container with a coating or doping with silver ions achieves the effect that the cryostat no longer has to be opened, as often or as long for cleaning operations. Brief opening to introduce and remove the specimens is adequate. The condensation of the inflowing air from the room is conducive to the antimicrobial effect of the surface of the inner container. Therefore, manual removal of the cutting waste as and when required and careful cleaning at the end of a laboratory day are often adequate.

The invention is described and explained in more detail below on the basis of an exemplary embodiment schematically represented in the drawing, in which:

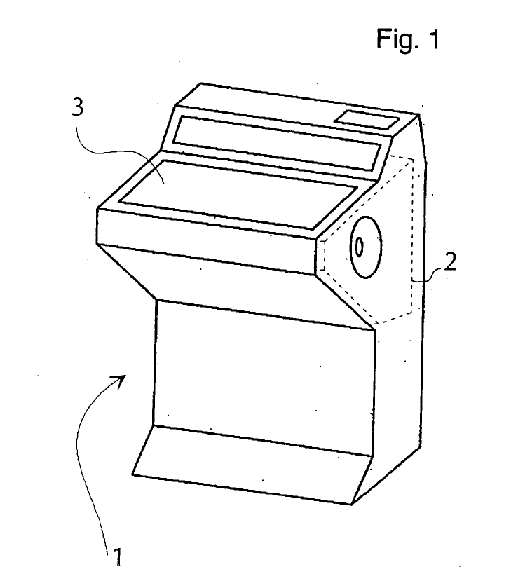

FIG. 1 shows a view of a cryostat,

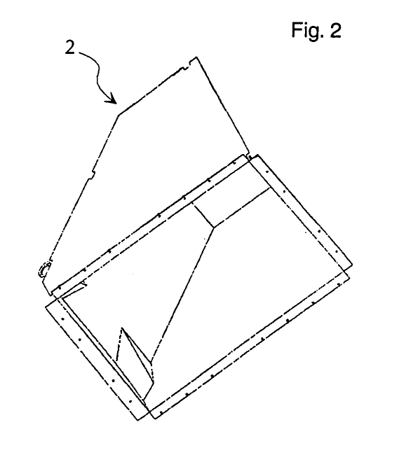

FIG. 2 shows an inner container,

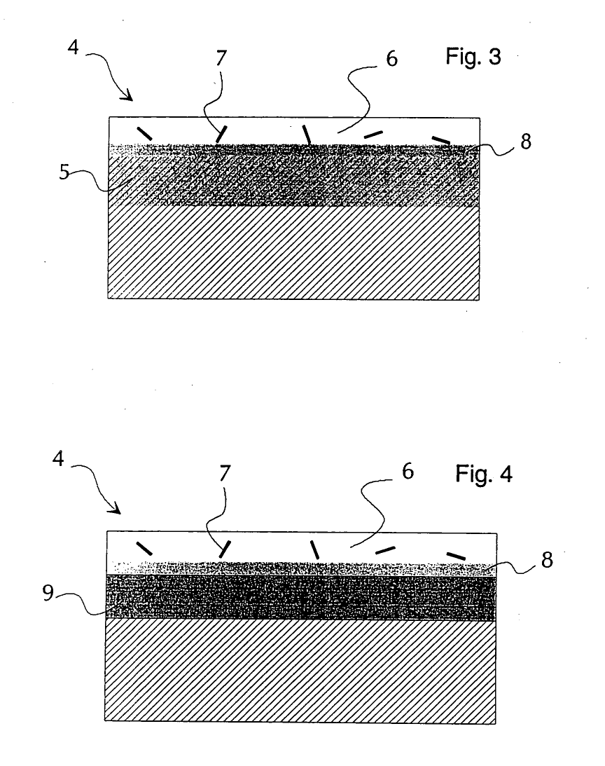

FIG. 3 shows a section through the material of an inner container with a doping and

FIG. 4 shows a section through the material of an inner container with a coating of a ceramic carrier material.

FIG. 1 shows a view of a cryostat 1 with an inner container 2, which can be hung in place, and a viewing panel 3, which closes the inner container and can be swung open.

In FIG. 2, the inner container 2, which is formed in one piece and is produced by the deep-drawing process, can be seen on its own.

FIG. 3 shows a section through the housing wall 4 of the inner container 2, which is provided on the inner side with a doping 5 of free silver ions. On the doped surface of the inner container 2, moisture is precipitated in a film 6 and cuttings are deposited. Bacteria 7 may also occur in this film, but they are killed off by the release of silver ions 8 at the boundary layer of the inner side.

FIG. 4 shows another section through the housing wall 4 of the inner container 2, a coating 9 of a ceramic carrier material having been applied on the inner side. Inorganic zeolite may be provided for example as carrier material.

1) A cryostat for cutting frozen specimens and preparations, with an inner container (2) for receiving a microtome, wherein the inner container (2) is formed in one piece and made of high-grade steel and has a coating (9) with soluble silver ions (8).

2) The cryostat as claimed in claim 1, wherein the coating (9) comprises a release system with constant and controlled liberation of silver ions (8).

3) The cryostat as claimed in claim 2, wherein the coating (9) consists of a ceramic material as a carrier for storing the silver ions (8).

4) The cryostat as claimed in claim 2, wherein the release system can be activated by the moisture of the air in the interior space of the cryostat (1).

5) The cryostat as claimed in claim 1, wherein the inner container (2) is produced by the deep-drawing process.
